(19) United States
(12) Patent Application Publication
(10) Pub. No.: US 2026/0231269 A1
(43) Pub. Date: Aug. 6, 2026

(54) METHODS, ARCHITECTURES, APPARATUSES AND SYSTEMS FOR INDICATING BANDWIDTH PARTS FOR SMALL DATA TRANSMISSION

(71) Applicant: InterDigital Patent Holdings, Inc., Wilmington, DE (US)

(72) Inventors: Samuli Turtinen, Ii (FI); Faris Alfarhan, Montreal (CA); Paul Marinier, Brossard (CA); Brian Martin, Farnham (GB)

(21) Appl. No.: 19/043,852

(22) Filed: Feb. 3, 2025

(51) Int. Cl. H04W 76/20; H04W 72/0457; H04W 74/0836

(52) U.S. Cl. CPC H04W 76/20; H04W 72/0457; H04W 74/0836

(57) ABSTRACT

In one embodiment, a wireless transmit/receive unit (WTRU) may receive configuration information indicating a small data transmission (SDT) configuration. The WTRU may receive system information indicating that SDT is configured for a cell. The WTRU may perform, according to the configuration information and/or the system information, a SDT procedure. The SDT procedure may include the WTRU sending information indicating a downlink (DL) bandwidth part (BWP) associated with the SDT procedure, and receiving one or more DL transmissions associated with the SDT procedure using the indicated DL BWP.

### BACKGROUND

The present application is related to the fields of communications, software and encoding, including, for example, to methods, architectures, apparatuses, systems directed to indicating a bandwidth part (BWP) for small data transmission (SDT), and more specifically to SDT procedures using an indicated BWP.

SDT is specified in 3GPP 5G NR Releases 17 and 18. A Stage-2 description of the NR SDT feature is provided in TS 38.300 under Section 18.

Briefly stated, SDT is a procedure allowing data and/or signalling transmission while remaining in the RRC_INACTIVE state (i.e. without transitioning to the RRC_CONNECTED state). SDT is enabled on a radio bearer basis and can be initiated either by the WTRU in the case of Mobile Originated SDT (MO-SDT) or by the network in the case of Mobile Terminated SDT (MT-SDT). MO-SDT is initiated by the WTRU only if less than or equal to a configured amount of UL data awaits transmission across all radio bearers for which SDT is enabled, the downlink (DL) reference signal received power (RSRP) is above a configured threshold, and a valid SDT resource is available as specified in clause 5.27.1 of TS 38.321. MT-SDT is initiated by the network with an indication to the UE in a paging message when DL data awaits transmission for radio bearers configured for SDT; based on the indication, the WTRU initiates the MT-SDT only if the DL RSRP is above a configured threshold as specified in clause 5.27.1 of TS 38.321. When MT-SDT is initiated by the WTRU, a resume cause indicating MT-SDT is included in a RRCResumeRequest/RRCResumeRequest1 message. The maximum duration the SDT procedure can last is dictated by a SDT failure detection timer that is configured by the network as in clause 6.2.2 of TS 38.331. The network can enable MO-SDT, MT-SDT, or both in a cell.

The SDT procedure is initiated with either a transmission over the Random Access Channel (RACH) (e.g., which is configured via system information) or over a Type 1 configured grant (CG) resource (e.g., which is configured via dedicated signalling in a RRCRelease message).

Once initiated, the SDT procedure is either: (i) successfully completed after the WTRU is directed to RRC_IDLE (e.g., via a RRCRelease message) or to continue in RRC_INACTIVE (e.g., via a RRCRelease or RRCReject message) or to RRC_CONNECTED (e.g., via a RRCResume or RRCSetup message); or (ii) unsuccessfully completed upon cell re-selection, expiry of the SDT failure detection timer, a Medium Access Control (MAC) entity reaching a configured maximum Physical Random Access Channel (PRACH) preamble transmission threshold, a Radio Link Control (RLC) entity reaching a configured maximum retransmission threshold, or an integrity check failure while SDT procedure is ongoing, or an expiry of a SDT-specific timing alignment timer or configuredGrantTimer while SDT procedure is ongoing over CG and the WTRU has not received a response from the network after the initial Physical Uplink Shared Channel (PUSCH) transmission.

It would be beneficial to provide techniques for the WTRU to enable application of a particular BWP (e.g., the initial DL BWP) during the SDT procedure and to indicate to the network which BWP is applied.

### BRIEF SUMMARY

Briefly stated, in one embodiment, a WTRU may receive a SDT configuration. For example, the SDT configuration may be provided by RRC configuration and system information. The WTRU system information indicating that SDT is configured for a cell. The WTRU may initiate a SDT procedure with the cell. The WTRU may send information indicating a DL BWP associated with the SDT procedure. The WTRU may receive any of SDT signaling, SDT data, and/or RRC messaging using the indicated DL BWP.

In one embodiment, a WTRU may receive configuration information indicating (e.g., at least part of) a SDT configuration. The WTRU may receive system information indicating that SDT is configured for a cell (e.g., that SDT is enabled or allowed in the cell). For example, the system information may include information indicating (e.g., at least part of) a SDT configuration. The WTRU may perform, according to the configuration information and/or the system information, a SDT procedure which includes to: send information indicating a DL BWP (e.g., initial DL BWP) associated with (e.g., to be used during) the SDT procedure, and receive one or more DL transmissions (e.g., DL SDT data and/or signaling) associated with the SDT procedure using the indicated DL BWP.

In one embodiment, a WTRU may receive information indicating a SDT configuration. The WTRU may perform a SDT procedure. For example, the SDT procedure may include the WTRU sending, using a CG resource, a PUSCH transmission which includes a RRCResumeRequest messageand an indication of a DL BWP, and receiving, using resources of the DL BWP, (i) one or more DL SDT payloads and/or (ii) a RRC message.

In one embodiment, a WTRU may receive information indicating a SDT configuration. The WTRU may perform a RA-SDT procedure. The RA-SDT procedure may be performed using a 2-step RA procedure. For example, the RA-SDT procedure may include the WTRU sending a MsgA which includes a preamble indicating a DL BWP, and receiving, using resources of the DL BWP, any of (i) a MsgB, (ii) one or more DL SDT payloads and/or (iii) a RRC message.

In one embodiment, a WTRU may receive information indicating a SDT configuration. The WTRU may perform a RA-SDT procedure. The RA-SDT procedure may be performed using a 4-step RA procedure. For example, the RA-SDT procedure may include the WTRU sending a Msg1, receiving a Msg2, sending a Msg3 which includes an indication of a DL BWP, and receiving a Msg4. The WTRU may receive, using resources of the DL BWP, (i) one or more DL SDT payloads and/or (ii) a RRC message.

In one embodiment, a WTRU may receive information indicating a SDT configuration. The WTRU may perform a RA-SDT procedure. For example, the RA-SDT procedure may include the WTRU sending a Msg1, receiving a Msg2, sending a Msg3 which includes an indication of a DL BWP and an UL SDT payload, and receiving, using resources of the indicated DL BWP, (i) a Msg4 and any of (ii) one or more DL SDT payloads and/or (iii) a RRC message.

In one embodiment, a base station (e.g., gNB, 6G node) may send configuration information indicating a SDT configuration. The base station may send system information associated with SDT. The base station may perform, according to the configuration information and/or the system information, a SDT procedure. For example, the SDT procedure may include the base station receiving, from a WTRU, information indicating a downlink (DL) bandwidth part (BWP) associated with the SDT procedure, and sending one or more DL transmissions associated with the SDT procedure using the indicated DL BWP.

### BRIEF DESCRIPTION OF THE DRAWINGS

The following detailed description will be better understood when read in conjunction with the appended drawings, in which there are shown examples of one or more of the multiple embodiments of the present disclosure. It should be understood, however, that the embodiments described herein are not limited to the precise arrangements and instrumentalities shown in the drawings. In the drawings:

FIG. 1A is a system diagram illustrating an example communications system, according to one or more embodiments of the present disclosure;

FIG. 1B is a system diagram illustrating an example wireless transmit/receive unit (WTRU) that may be used within the communications system illustrated in FIG. 1A, according to one or more embodiments of the present disclosure;

FIG. 1C is a system diagram illustrating an example radio access network (RAN) and an example core network (CN) that may be used within the communications system illustrated in FIG. 1A, according to one or more embodiments of the present disclosure;

FIG. 1D is a system diagram illustrating a further example RAN and a further example CN that may be used within the communications system illustrated in FIG. 1A, according to one or more embodiments of the present disclosure;

FIG. 2 is a frequency diagram illustrating an example size comparison of the DL BWP and CORESET #0, according to one or more embodiments of the present disclosure;

FIG. 3 is a procedural diagram illustrating an example procedure for indicating a DL BWP associated with a SDT procedure, according to one or more embodiments of the present disclosure;

FIG. 4 is a procedural diagram illustrating another example procedure for indicating a DL BWP associated with a SDT procedure, according to one or more embodiments of the present disclosure;

FIG. 5 is a procedural diagram illustrating an example procedure for indicating a DL BWP associated with a SDT procedure using a CG resource, according to one or more embodiments of the present disclosure;

FIG. 6 is a procedural diagram illustrating an example procedure for indicating a DL BWP associated with a SDT procedure using RA, according to one or more embodiments of the present disclosure;

FIG. 7 is a procedural diagram illustrating another example procedure for indicating a DL BWP associated with a SDT procedure using RA, according to one or more embodiments of the present disclosure;

FIG. 8 is a procedural diagram illustrating another example procedure for indicating a DL BWP associated with a SDT procedure using RA, according to one or more embodiments of the present disclosure; and

FIG. 9 is a procedural diagram illustrating another example procedure for a SDT procedure using an indicated DL BWP, according to one or more embodiments of the present disclosure.

### DETAILED DESCRIPTION

In describing the various embodiments of the present disclosure, certain terminology is used herein for convenience only and should not be considered as limiting such embodiments. In the drawings, the same reference numerals are employed for designating the same elements throughout the several figures and the present description.

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

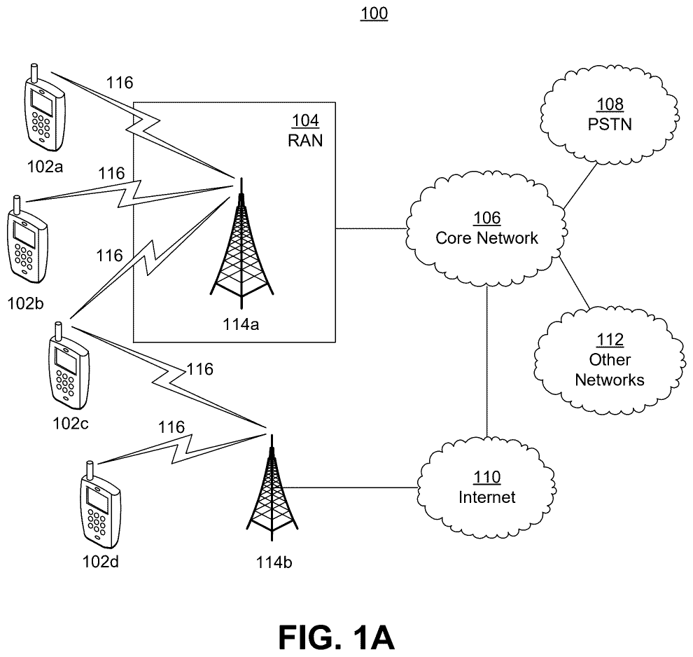

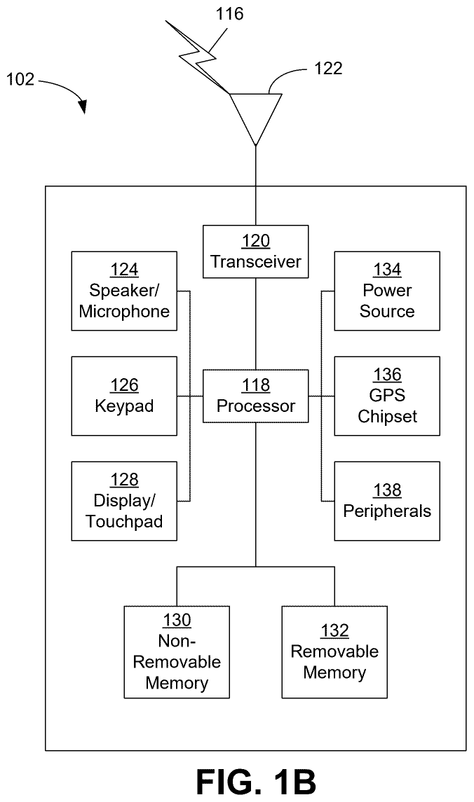

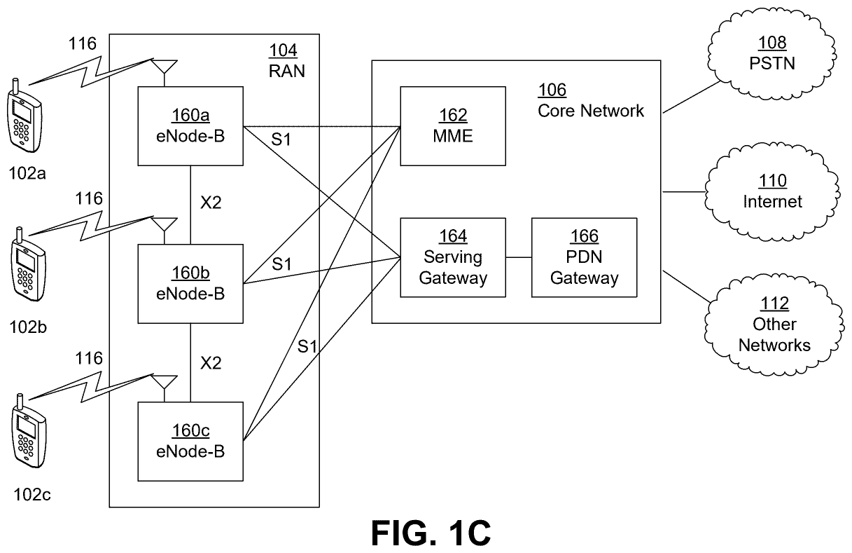

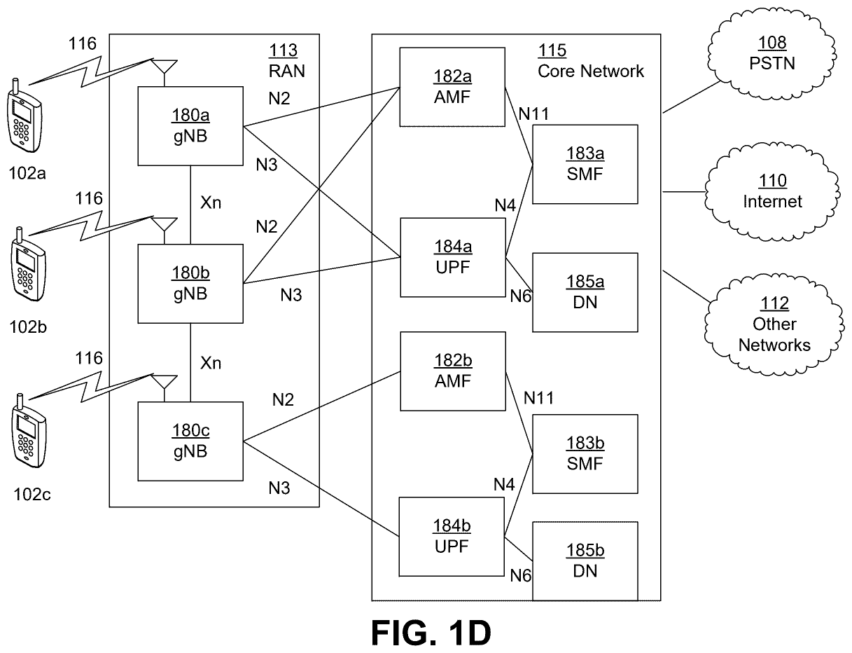

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Introduction

The following abbreviations and acronyms may be used throughout the description:
BWP Bandwidth Part
CCCH Common Control Channel
CG Configured Grant
CS-RNTI Configured Scheduling RNTI
CR Contention Resolution
DCI Downlink Control Information
DL Downlink
DRB Data Radio Bearer
I-RNTI Inactive RNTI
LCID Logical Channel Identifier
MAC Medium Access Control
MO Mobile Originated
MT Mobile Terminated
NW Network
PDCCH Physical Downlink Control Channel
PDSCH Physical Downlink Shared Channel
PUSCH Physical Uplink Shared Channel
PDU Protocol Data Unit
RA Random Access
RAR Random Access Response
RNTI Radio Network Temporary Identifier
RSRP Reference Signal Received Power
SIB System Information Block
SDT Small Data Transmission
SDU Service Data Unit
SR Service Request
SRB Signaling Radio Bearer
TA Timing Alignment

In 3GPP 5G NR Release 18, the BWP used for an SDT procedure is limited to the initial BWP in the UL and the CORESET #0 BW for DL. That is, the WTRU 102 does not apply the initial DL BWP until it receives a RRCResume/RRCSetup/RRCReestablishment message during the RRC Resume/Establishment/Reestablishment procedures, respectively. However, UE does not receive any of these messages during the SDT procedure as specified in TS 38.331. The initialDownlinkBWP specifies the initial downlink BWP configuration for a PCell. The network configures the locationAndBandwidth field so that the initial downlink BWP contains the entire CORESET #0 of this serving cell in the frequency domain. The WTRU 102 applies the locationAndBandwidth upon reception of this field (e.g., to determine the frequency position of signals described in relation to this locationAndBandwidth) but the WTRU 102 keeps CORESET #0 until after reception of the RRCSetup/RRCResume/RRCReestablishment message.

As specified in TS 38.212, the following information is transmitted by means of the DCI format 1_0 with CRC scrambled by TC-RNTI:
an identifier for DCI formats—1 bit, where the value of this bit field is always set to 1, indicating a DL DCI format; and
a frequency domain resource assignment—bits, where is the size of CORESET 0.

This is also specified in L1 specification as follows.

In TS 38.212, the same restriction is applicable for subsequent transmissions as well. As specified in clause 7.3.1.2.1 of TS 38.212, the following information is transmitted by means of the DCI format 1_0 with CRC scrambled by C-RNTI or CS-RNTI or MCS-C-RNTI:
Identifier for DCI formats—1 bits, where the value of this bit field is always set to 1, indicating a DL DCI format; and
a frequency domain resource assignment—bits, where is given by Clause 7.3.1.0.

As specified in section 7.3.1.0 of TS 38.212, a WTRU 102 may determine the DCI format 1_0 to be monitored in a common search space according to clause 7.3.1.2.1 where is given by:
the size of CORESET 0 if CORESET 0 is configured for the cell; and
the size of initial DL bandwidth part if CORESET 0 is not configured for the cell.

According to the above, the DL BW is limited compared to the UL BW throughout the SDT procedure and may, hence, delay the completion of the SDT procedure and increase UE power consumption.

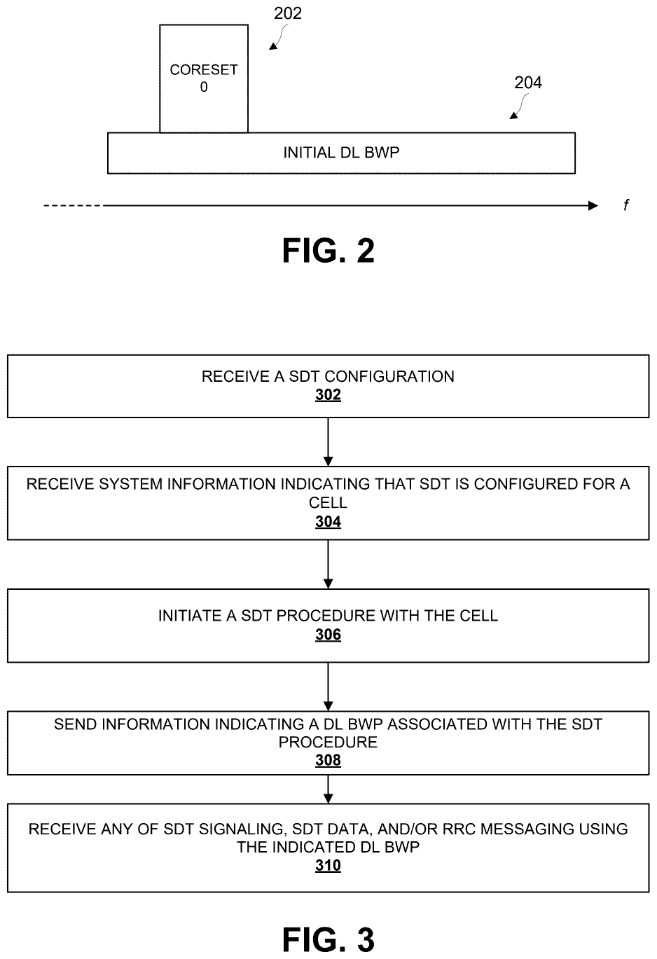

FIG. 2 is a frequency diagram illustrating an example size comparison of the DL BW and CORESET 0, according to one or more embodiments of the present disclosure. As seen in FIG. 2, a size of the CORESET 0 202 is relatively smaller than a size of the initial DL BWP 204.

In some cases, the network (e.g., a gNB 180, a 6G node) may not know if a WTRU 102 supports a DL BW (e.g., wider than CORESET 0) for SDT with RA-SDT where the WTRU 102 may resume its connection through SDT under another cell where it was directed to INACTIVE mode (e.g., and since there are legacy UEs). Hence, it may be beneficial to remove this limitation for SDT in the DL and apply an initial BWP in DL during the SDT procedure.

### Overview

In certain representative embodiments, a WTRU 102 may apply an indicated DL BWP, such as the initial DL BWP, during a SDT procedure. For example, during the SDT procedure the WTRU 102 may indicate to the network (e.g., gNB 180, a 6G node, a base station) a (e.g., DL) BWP to apply during the SDT procedure.

In certain representative embodiments, a WTRU 102 may select between an initial DL BWP and a CORESET #0 BWP to be applied (e.g., used) during a SDT procedure.

In certain representative embodiments, a WTRU 102 may select, such as upon initiation of a SDT procedure, a BWP (e.g., UL and/or DL BWP) from a plurality of BWPs, such as between a first DL BWP and a second BWP, to be applied (e.g., used) during a SDT procedure. The WTRU 102 may send an indication of the selected BWP to the network.

In certain representative embodiments, the WTRU 102 may apply the selected BWP during the SDT procedure, such as after receiving confirmation of the selected BWP. In certain representative embodiments, the WTRU 102 may apply another BWP (e.g., a BWP different than the selected BWP) during the SDT procedure, such as after receiving confirmation of the other BWP.

### Terminology

The terms “CORESET #0 BW” and “CORESET #0 BWP” may be used herein to refer to a special type of Control Resource Set (CORESET) in NR which carries the Physical Downlink Control Channel (PDCCH) (e.g., Downlink Control Information (DCI)) for System Information Block 1 (SIB1). The resource allocation (e.g., time and frequency domain resource allocation) for CORESET #0 may be configured by the Master Information Block (MIB), which may be received in a Physical Broadcast Channel (PBCH) in a Synchronization Signal/PBCH block (SSB). Other types of CORESETs may be configured by SIB or a RRCSetup/RRCReconfiguration message. In some embodiments, CORESET #0 may not be configured by SIB or other RRC message because the CORESET #0 should be known before the SIB or other RRC messaging is detected.

For example, the CORESET #0 BW may define the DL BW for a WTRU 102 to operate before reception of any of RRCSetup, RRCResume, and/or RRCReestablishment messages.

The term “initial BWP” may be used herein to refer to the BWP configured in SIB1 as initialDownlinkBWP. In some embodiments, the initial BWP may include a separate configuration (e.g., for physical uplink (UL) and/or DL channels, such as PDCCH/PDSCH/PUSCH) as compared to CORESET #0 but the initial BWP may (e.g., shall) contain the entire CORESET #0 BW in the frequency domain.

In some embodiments, the CORESET #0 BW/BWP and the initial DL BWP may be generalized to first and second BWPs.

The term “Msg 1” may be used herein to refer to the preamble transmission for 4-step RA.

The term “Msg2” may be used herein to refer to the RAR in response to Msg1. For example, Msg2 may include information indicating a TA command for timing adjustment, a RA preamble ID, and/or an initial uplink grant for the UE.

The term “Msg3” may be used herein to refer to the first scheduled (e.g., PUSCH) transmission for 4-step RA.

The term “Msg4” may be used herein to refer to the contention resolution message in response to Msg3. For example, Msg4 may include information indicating that contention has been resolved.

The term “MsgA” may be used herein to refer to preamble and payload transmission for 2-step RA type.

The term “MsgB” may be used herein to refer to the response to MsgA for 2-step RA. For example, MsgB may include any of response(s) for contention resolution, fallback indication(s), and/or a backoff indication.

### SDT Configuration

In certain representative embodiments, a WTRU 102 may receive SDT configuration information through a first type (e.g., layer) of signaling, such as RRC signaling (e.g., a RRCRelease message with a suspendConfig). In certain representative embodiments, a WTRU 102 may receive SDT configuration information through another type (e.g., layer) of signaling, such as MAC signaling (e.g., a MAC CE). For example, a SDT configuration may be received via the multiple types of signaling (e.g., RRC signaling, MAC signaling, system information). For example, a SDT configuration may include information associated with data restrictions for a SDT procedure and/or resource configurations for the SDT procedure.

As an example according to one or more embodiments, a SDT configuration may include information indicating any of the following:
an allowed SDT DRB and/or SRB list;
an allowed QoS flow list;
a CG-SDT configuration; and/or
restrictions as to which data to map to which type of grant (e.g., dynamic grant or configured grant or specific configured grant).

As an example according to one or more embodiments, a CG-SDT configuration may include information indicating any of the following:
a time alignment timer (e.g., a TA value for SDT);
one or more SDT thresholds (e.g., a RSRP threshold for SDT);
TA validation configuration, like RSRP threshold (for example, the TA remains valid unless the measured RSRP changes more than the RSRP threshold);
a RNTI value (e.g., CS-RNTI);
a PDCCH configuration;
a PDSCH configuration;
a PUSCH configuration; and/or
one or more CG configurations.

In some embodiments, a CG-SDT configuration may be provided as part of a SDT configuration. A WTRU 102 may receive a configuration to apply the initial DL BWP upon initiating a CG-SDT procedure. For example, an (e.g., additional) indication may be encoded in the CG-SDT configuration to apply the initial DL BWP upon initiating the CG-SDT procedure. For example, if the indication is absent, the WTRU 102 may apply the CORESET #0 for DL BWP during the CG-SDT procedure. For example, the information indicating which DL BWP to apply for SDT may be subject to CG-SDT being performed in the same serving cell where the SDT configuration was received.

In some embodiments, a WTRU 102 may receive a configuration for performing a SDT procedure (e.g., only) when application of the initial DL BWP for SDT procedure is supported by the network (e.g., cell, gNB 180, 6G node, base station). For example, the configuration may be limited to a specific SDT type, such as any of MT-SDT, MO-SDT, and/or CG-SDT. Support of applying the initial DL BWP for a SDT procedure may be (e.g., indicated) received through system information (e.g., in SIB1).

In some embodiments, a WTRU 102 may receive a channel quality configuration (e.g., a RSRP threshold) based on which the WTRU 102 may apply either a first BWP (e.g., CORESET #0 DL BWP) or a second BWP (e.g., initial DL BWP) for the SDT procedure. For example, the WTRU 102 may determine whether to apply a first BWP or a second BWP for a SDT procedure based, at least in part, on one or more measurements. For example, if the RSRP is below the RSRP threshold, the WTRU 102 may apply the initial DL BWP for the SDT procedure. For example, if the RSRP is above the RSRP threshold, the WTRU 102 may apply the CORESET #0 DL BWP for the SDT procedure.

### System Information

In certain representative embodiments, a WTRU 102 may receive SDT configuration information via system information signaling. For example, a WTRU 102 may receive a (e.g., common) SDT configuration for a given serving cell through system information signaling, such as in a system information block (e.g., SIB1) including sdt-ConfigCommon.

As an example according to one or more embodiments, a common SDT configuration (e.g., for a serving cell) may include information indicating any of the following:
a (e.g., maximum) data volume threshold based on which the WTRU 102 may initiate the SDT procedure (e.g., if the buffered UL data for radio bearers and/or logical channels configured for SDT is less than the configured threshold level);
a RSRP threshold based on which the WTRU 102 may initiate the SDT procedure (e.g., if the channel RSRP is greater than the configured threshold level);
a SR delay timer based on which the WTRU 102 may delay initiation of a SR procedure during the SDT procedure (e.g., the SR procedure may require or follow a random access procedure);
a set of RA (RACH) preambles (e.g., for SDT, which may be associated to specific BWPs) and/or
a timer to dictate a maximum duration of the SDT procedure.

In some embodiments, a SDT configuration information may be provided by the network which may be common for both MO-SDT and MT-SDT. In other embodiments, a SDT configuration information may be provided by the network separately for MO-SDT and MT-SDT.

In certain representative embodiments, a WTRU 102 may (e.g., also) receive information indicating the initial DL BWP configuration, such as for a given serving cell, through system information (e.g., from SIB1).

In some embodiments, system information, such as for a given serving cell, may include information indicating that application of the initial DL BWP for SDT procedure is supported. For example, information indicating support of a BWP (e.g., the initial DL BWP indication) may be provided in a common SDT configuration. For example, a WTRU 102 receiving this indication may determine to use either the CORESET #0 or the initial DL BWP for a SDT procedure.

In some embodiments, system information, such as for a given serving cell, may include information indicating that (e.g., only) a WTRU 102 that supports the application of the initial DL BWP can perform SDT (e.g., in the cell). For example, the network may indicate that it intends to use only the initial DL BWP for SDT. Based on such an indication, the WTRU 102 may determine to apply the initial DL BWP for the SDT procedure. For example, the indication may be provided as a separate common SDT configuration as described above (e.g., to prevent legacy WTRUs from using SDT that do not support application of the initial DL BWP for SDT procedure). For example, the network may apply the restriction that only WTRUs that do support the application of initial DL BWP may be applicable only for those WTRUs 102 that support both the CORESET #0 BWP and the initial DL BWP application for a SDT procedure. As an example, a WTRU 102 may be required to indicate (e.g., in the RA Msg3 or in the initial CG-SDT transmission) that the WTRU 102 supports and/or applies the initial DL BWP for the SDT procedure. For example, the indication over the system information may also be provided in the common SDT configuration.

In some embodiments, system information may include information indicating which BWP (e.g., CORESET #0 DL BWP or initial DL BWP) the cell uses for SDT. Based on such indication, a WTRU 102 may determine which (e.g., DL) BWP to apply for the SDT procedure. For example, this indication may be be provided similarly to other examples herein.

In certain representative embodiments, any of the indications described herein may be common to both MO-SDT and MT-SDT procedures. In certain other representative embodiments, any of the indications described herein may be specific to MO-SDT or MT-SDT procedures.

In certain representative embodiments, any of the indications described herein may be common to both RA-SDT and CG-SDT procedures. In certain other representative embodiments, any of the indications described herein may be specific to RA-SDT or CG-SDT procedures.

In some embodiments, a WTRU 102 may receive a channel quality configuration (e.g., via system information), such as may include a RSRP threshold,. The WTRU 102 may determine whether to apply either a first BWP (e.g., CORESET #0 DL BWP) or a second BWP (e.g., initial DL BWP) for the SDT procedure in a given serving cell based on the channel quality configuration. For example, if the RSRP is below a RSRP threshold indicated in a channel quality configuration, the WTRU 102 may apply the initial DL BWP for the SDT procedure. For example, if the RSRP is above the RSRP threshold, the WTRU 102 may apply the CORESET #0 DL BWP for the SDT procedure.

### Paging Information

In certain representative embodiments, a WTRU 102 may receive information indicating to perform a MT-SDT procedure through a paging message. For example, the WTRU 102 may receive an (e.g., explicit) indication to perform a MT-SDT procedure. Based on such indication, the WTRU 102 may attempt to initiate a MT-SDT procedure.

In some embodiments, a paging message may include information indicating whether to apply the CORESET #0 BWP or the initial DL BWP for the SDT procedure. Based on the indication, the WTRU 102 can apply the corresponding DL BWP directly for the SDT procedure. For example, the paging message may include information indicating the application of the initial DL BWP for the SDT procedure.

As an example, the WTRU 102 may apply the corresponding DL BWP immediately after initiating a CG-SDT procedure. As an example, the WTRU 102 may apply the corresponding DL BWP after transmitting Msg3 for RA-SDT, or after receiving Msg4 from the network (e.g., only after successful contention resolution). Applying the corresponding DL BWP after transmitting Msg3 may allow the network to schedule Msg4 with a wider BW and potentially transmit more data to the WTRU 102. However, the contention resolution failure determination may be performed based on the contention resolution timer and may delay the failure determination. Applying the corresponding DL BWP after receiving Msg4 from the network, may allow for a faster contention resolution failure determination (e.g., when receiving Msg4 with a wrong CR ID) but may provide a limited BW for Msg4 transmission (e.g., CORESET #0 BW).

In some embodiments, a paging message may include information indicating a channel quality configuration. For example, a paging message may (e.g., explicitly or implicitly) indicate a RSRP threshold, such as pointing to a specific RSRP threshold configured over system information. A WTRU 102 may determine to apply either a first BWP (e.g., CORESET #0 BW) or a second BWP (e.g., initial DL BWP) for the SDT procedure. For example, if WTRU 102 determines the RSRP is below the RSRP threshold, the WTRU 102 may apply the initial DL BWP for a SDT procedure. For example, if the WTRU 102 determines the RSRP is above the RSRP threshold, the WTRU 102 may apply the CORESET #0 DL BWP for the SDT procedure.

### SDT Initiation

In certain representative embodiments, a WTRU 102 may determine to initiate an SDT procedure, such as for MO-SDT or MT-SDT. In some embodiments, an SDT procedure may include the transmission of both MO and MT data and/or signaling.

For example, a SDT procedure may be initiated, such as for MO-SDT, upon the WTRU 102 determining that (i) UL data awaiting transmission across all radio bearers for which SDT is enabled (e.g., buffered UL data for SDT) is less than or equal to a configured amount, (ii) a DL RSRP is above a configured threshold, and (iii) a valid SDT resource is available.

For example, a SDT procedure may be initiated, such as for MT-SDT, upon the WTRU 102 determining that (ii) a paging message indicates that DL data awaits transmission for radio bearers configured for SDT, and (ii) a DL RSRP is above a configured threshold.

In some embodiments, a WTRU 102 may first attempt to initiate a CG-SDT procedure (e.g., if configured with CG resources for SDT) and secondly attempt a RA-SDT procedure (e.g., if CG-SDT cannot be initiated or is not configured).

### CG-SDT Initiation

In certain representative embodiments, a WTRU 102 may determine to perform a CG-SDT procedure. For example, the WTRU 102 may determine to perform CG-SDT upon determining certain criteria are met. As an example, the WTRU 102 may determine that buffered UL data is below a configured data volume threshold, that a DL RSRP is above a configured RSRP threshold, that the DL RSRP has not changed more than a configured amount, time alignment with the base station (e.g., cell) is within a configured amount (e.g., the time alignment timer has not expired), and/or CG resources for SDT have been configured.

In some embodiments, a WTRU 102 may (e.g., explicitly or implicitly) indicate which DL BWP the WTRU 102 expects to use (e.g., will use) for the CG-SDT procedure (e.g., CORESET #0 BWP or initial DL BWP) in the initial CG-SDT transmission. For example, the indication may be performed when the network indicates support for application of the initial DL BWP for a SDT procedure, or when the UE applies a RSRP threshold to determine which DL BWP to apply for the SDT procedure. For example, the indication may be provided by means of a MAC CE or a LCID, such as may be used to indicate a CCCH SDU message in the MAC PDU. For example, the WTRU 102 may prefer the usage of CORESET #0 BW for the SDT procedure if it does not expect much DL traffic and, hence, could save more power by not applying the initial DL BWP.

For example, the WTRU 102 may include an indication of the DL BWP to be applied for the SDT procedure in the initial CG-SDT transmission. As an example, the initial CG-SDT transmission may include any of a CCCH message, a SDT payload (e.g., buffered UL data), and/or the indication of the (e.g., DL) BWP to be applied.

In certain representative embodiments, the WTRU 102 may determine whether the initial DL BWP or CORESET #0 BWP is to be used for the CG-SDT procedure and applies the initial DL BWP or CORESET #0 upon initiation of the CG-SDT procedure.

In certain representative embodiments, the WTRU 102 may determine whether the initial DL BWP or CORESET #0 BWP is to be used for the CG-SDT procedure and applies the initial DL BWP or CORESET #0 upon receiving a first PDCCH transmission addressed to the C-RNTI of the WTRU 102 after the initial CG-SDT transmission.

### RA-SDT Initiation

In certain representative embodiments, a WTRU 102 may determine to perform a RA-SDT procedure. For example, the WTRU 102 may determine to perform RA-SDT upon determining certain criteria are met. As an example, the WTRU 102 may determine that buffered UL data is below a configured data volume threshold, that a DL RSRP is above a configured RSRP threshold, that the DL RSRP has not changed more than a configured amount, time alignment with the base station (e.g., cell) is outside of a configured amount (e.g., the time alignment timer has not expired), and/or CG resources for SDT have not been configured.

In some embodiments, a WTRU 102 may apply the initial DL BWP for the RA-SDT procedure upon successful completion of the RA procedure (e.g., 2-step or 4-step RA) for SDT, or upon successful contention resolution. The RA procedure may be determined to be successfully completed, such as upon successful contention resolution. For example, the RA procedure may determined to be successfully completed when Msg4 from the network is received indicating the contention resolution ID of the WTRU 102.

In some embodiments, the WTRU 102 may receive a contention resolution message (e.g., Msg4) for the RA procedure and receive an indication within the contention resolution message. For example, the indication may indicate whether to apply the initial DL BWP for the remainder of the SDT procedure or continue with CORESET #0 BW. For example, the indication may be provided by the DCI scheduling the Msg4, or by a MAC CE within a MAC PDU of the Msg4.

In some embodiments, a WTRU 102 may indicate in a Msg1 (e.g., RA preamble) which DL BWP it expects to use (e.g., uses) for the SDT procedure (e.g., CORESET #0 or initial DL BWP). For example, the network may allocate a set of RA preambles for indicating the BWP (e.g., preferred by the WTRU 102). As an example, a set of RA preambles may be configured to indicate the initial DL BWP, such preambles may be distinct from the RA preambles used to solely indicate SDT (e.g., as in Release 17 and 18) and/or CORESET #0 BWP usage.

In some embodiments, the WTRU 102 may indicate in a Msg3 which DL BWP it expects to use (e.g., uses) for the SDT procedure (e.g., CORESET #0 or initial DL BWP). For example, the indication may be performed when (e.g., after) the network indicates support for application of initial DL BWP for the SDT procedure, or when the WTRU 102 applies the RSRP threshold to determine which DL BWP to apply for SDT procedure. For example, the indication may be provided by a LCID. For example, the LCID may (e.g., further) indicate a CCCH SDU. For example, the LCID may indicate the initial DL BWP and a CCCU SDU size, such as 48 (e.g., for RRCResumeRequest 1) or 64 bits (e.g., for RRCResumeRequest). As an example, two LCIDs may be reserved for the purpose of indicating the BWP and the CCCU SDU size.

In some embodiments, the WTRU 102 may receive an indication of (e.g., support) for the switch the WTRU's indicated BWP. For example, the WTRU 102 may receive a RRC message (e.g., RRCReconfiguration message) indicating to switch to the initial DL BWP.

### SDT Procedures

In certain representative embodiments, a WTRU 102 may apply a (e.g., different) DL BWP for a SDT procedure, such as upon initiation of the SDT procedure or during the SDT procedure.

In certain representative embodiments, a WTRU 102 may send (e.g., to a gNB 180, a 6G node, or other base station) an indication of a (e.g., DL) BWP which is (e.g., to be) applied for the SDT procedure.

In certain representative embodiments, a WTRU 102 may receive configuration information for SDT, such as in a RRCRelease message with a suspendConfig. For example, the WTRU 102 may receive a SDT configuration which may include a MO-SDT and/or a MT-SDT configuration. The SDT configuration may include a CG-SDT configuration. For example, a CG-SDT configuration may configure the WTRU 102 to apply the initial DL BWP, such as upon initiating the CG-SDT procedure (e.g., in a same cell in which the SDT configuration was received). For example, the WTRU 102 may receive a configuration to perform an SDT procedure (e.g., only) when application of the initial DL BWP for SDT procedure is supported by the network (e.g., cell, gNB 180, 6G node, or other base station). In some embodiments, the configuration (e.g., to apply the initial DL BWP) may be limited to a specific SDT type, such as MT-SDT. In some embodiments, support of the application of the initial DL BWP for a SDT procedure may be indicated through system information (e.g., in SIB1).

In certain representative embodiments, a WTRU 102 may receive system information indicating that SDT is configured for the cell. For example, the system information may include a RA-SDT configuration. For example, the system information may (e.g., further) indicate that the cell supports application of the initial DL BWP for a SDT procedure. As an example, the system information may indicate that (e.g., only) WTRUs that do support the application of the initial DL BWP can perform SDT in the cell. As an example, the system information may indicate which BWP (e.g., CORESET #0 BWP or initial DL BWP) the network (e.g., cell) uses for SDT. In some embodiments, the system information may indicate that any of the above are common to or specific to MO-SDT or MT-SDT.

In some embodiments for MT-SDT, a WTRU 102 may receive paging information (e.g., a paging message) indicating initiation of a MT-SDT procedure. For example, the paging information may indicate to the WTRU 102 whether to apply the CORESET #0 BWP or initial DL BWP for the SDT procedure.

In some embodiments for MT-SDT, a WTRU 102 may (e.g., determine to) initiate a SDT procedure. Examples of which are described herein.

In some embodiments for CG-SDT, the WTRU 102 may indicate which DL BWP the WTRU 102 expects to use (e.g., uses) for the CG-SDT procedure (e.g., CORESET #0 BWP or initial DL BWP) in the initial CG-SDT transmission (e.g., PUSCH transmission which includes a RRCResume message and SDT data). For example, the indication may be provided by means of a MAC CE or a LCID (e.g., used to indicate a CCCH SDU message in the MAC PDU). As an example, the WTRU 102 may prefer the usage of CORESET #0 BW for the SDT procedure if it does not expect much DL traffic and, hence, could save more power by not applying the initial DL BWP. For example, the WTRU 102 may determine whether the initial DL BWP is to be used for the CG-SDT procedure, and may apply the initial DL BWP upon initiation of the CG-SDT procedure or upon receiving a first PDCCH transmission addressed to the C-RNTI of the WTRU 102 after the initial CG-SDT transmission.

In some embodiments for RA-SDT, the WTRU 102 may apply the initial DL BWP for the SDT procedure upon successful completion of the RA procedure for SDT. For example, the WTRU 102 may receive a contention resolution message (e.g., Msg4) for the RA procedure, and receive an indication within the contention resolution message on whether to apply the initial DL BWP for the remainder of the SDT procedure or continue with the CORESET #0 BW. As an example, this indication may be provided via the DCI scheduling the Msg4 or as a MAC CE within the Msg4 MAC PDU. For example, the WTRU 102 may indicate in Msg1 (e.g., RA preamble) which DL BWP it expects to use (e.g., uses) for the SDT procedure (e.g., CORESET #0 BWP or initial DL BWP). For example, the network may allocate a (e.g., separate) set of RA preambles for indicating a BWP (e.g., the initial DL BWP). These preambles may be distinct from the RA preambles used to indicate SDT (e.g., Release 17 or 18 preambles associated with SDT).

For example, the RAR (e.g., Msg2) may indicate if the usage of a BWP (e.g., the initial DL BWP) is allowed, preferred or otherwise possible by the WTRU 102 receiving the RAR. For example, the WTRU 102 may indicate in Msg3 (e.g., PUSCH transmission) which DL BWP it expects to use (e.g., uses) for the SDT procedure (e.g., CORESET #0 or initial DL BWP). As an example, the indication may be provided by a LCID. As an example, the LCID may (e.g., further) indicate the CCCH SDU. For example, the LCID may indicate the initial DL BWP and the CCCU SDU size (e.g., of 48 or 64 bits). For example, two LCIDs may be reserved for the purpose. In some embodiments, a Msg3 indication may be sent if a Msg1-based indication is not configured.

For example, the WTRU 102 may receive a RRC message (e.g., RRCReconfiguration message) indicating to switch to the initial DL BWP. As an example, the WTRU 102 may be configured to use the CORESET #0 BWP or initial DL BWP for SDT procedure when the WTRU 102 performs the SDT procedure in the same cell where it was previously directed to INACTIVE mode (e.g., the cell which sent the RRCRelease message).

In some embodiments, the network may identify the BWP the WTRU 102 is (e.g., intending to) use in the DL for the SDT procedure based on the initial PUSCH transmission which includes a RRCResumeRequest message and I-RNTI of the WTRU 102.

The WTRU 102 may apply the indicated BWP for the remainder of the SDT procedure. For example, the WTRU 102 may apply the initial DL BWP for the remainder of the SDT procedure.

FIG. 3 is a procedural diagram illustrating an example procedure for indicating a DL BWP associated with a SDT procedure, according to one or more embodiments of the present disclosure. As shown in FIG. 3, a WTRU 102 may receive a SDT configuration at 302. For example, the SDT configuration may be provided by RRC configuration and system information. At 304, the WTRU 102 system information indicating that SDT is configured for a cell. At 306, the WTRU 102 may initiate a SDT procedure with the cell. At 308, the WTRU 102 may send information indicating a DL BWP associated with the SDT procedure. At 310, the WTRU 102 may receive any of SDT signaling, SDT data, and/or RRC messaging using the indicated DL BWP.

In some embodiments, the WTRU 102 may indicate an UL BWP associated with the SDT procedure at 308 (e.g., instead of a DL BWP). The WTRU 102 may send any of SDT signaling, SDT data, and/or RRC messaging using the indicated UL BWP. For example, one or more subsequent (e.g., after the initial SDT transmission) transmissions using the indicated UL BWP.

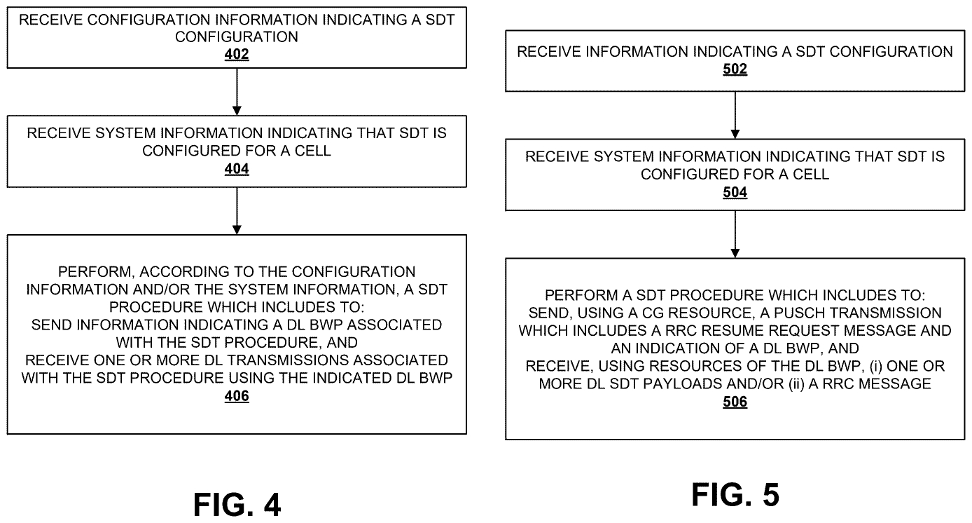

FIG. 4 is a procedural diagram illustrating another example procedure for indicating a DL BWP associated with a SDT procedure, according to one or more embodiments of the present disclosure. As shown in FIG. 4, a WTRU 102 may receive configuration information indicating (e.g., at least part of) a SDT configuration at 402. At 404, the WTRU 102 may receive system information indicating that SDT is configured for (e.g., enabled or allowed in) a cell. For example, the system information may include information indicating (e.g., at least part of) a SDT configuration. At 406, the WTRU 102 may perform, according to the configuration information and/or the system information, a SDT procedure which includes to: send information indicating a DL BWP (e.g., initial DL BWP) associated with (e.g., to be used during) the SDT procedure, and receive one or more DL transmissions (e.g., DL SDT data and/or signaling) associated with the SDT procedure using the indicated DL BWP.

In some embodiments, the indicated DL BWP may be an initial DL BWP or a CORESET #0 BWP.

In some embodiments, the system information may indicate that SDT using the indicated DL BWP is supported by the cell, and/or the configuration information is associated with the cell.

In some embodiments, the information indicating the DL BWP may be sent in an initial UL transmission using a CG resource associated with (e.g., indicated by) the SDT configuration. For example, the initial UL transmission may include a SDT payload (e.g., UL data and/or signaling), such as for MO-SDT.

In some embodiments, the WTRU 102 may receive, in response to the initial UL transmission using the CG resource, information indicating to use the indicated DL BWP to receive the one or more DL transmissions.

In some embodiments, the information indicating the DL BWP may be sent in a first message (e.g., MsgA) of a two-step RA procedure. For example, the first message may include a UL SDT payload, such as for MO-SDT.

In some embodiments, the information indicating the DL BWP may be a random access (e.g., RACH) preamble associated with the indicated DL BWP (e.g., in the configuration and/or system information).

In some embodiments, the information indicating the DL BWP may be sent in a third message (e.g., Msg3) of a four-step RA procedure. For example, the third message may include a UL SDT payload, such as for MO-SDT.

In some embodiments, the one or more DL transmissions associated with the SDT procedure may be received using the indicated DL BWP after completion of the RA procedure.

In some embodiments, the information indicating the DL BWP may be a LCID. In some embodiments, the LCID may (e.g., further) indicate (e.g., a size of) a CCCH SDU in a MAC PDU. For example, the LCID may indicate a first BWP to be applied and a first size of the CCCH SDU, or the LCID may indicate the first BWP to be applied and a second size of the CCCH SDU. In another example, the LCID may indicate a second BWP to be applied and a first size of the CCCH SDU, or the LCID may indicate the second BWP to be applied and a second size of the CCCH SDU. As an example, legacy LCID values may be used to indicate the first BWP and two (e.g., newly defined) LCID may be used to indicate the second BWP (e.g., and respective size of the CCCH SDU).

FIG. 5 is a procedural diagram illustrating an example procedure for indicating a DL BWP associated with a SDT procedure using a CG resource, according to one or more embodiments of the present disclosure. As shown in FIG. 5, a WTRU 102 may receive information indicating a SDT configuration at 502. At 504, the WTRU 102 may perform a SDT procedure. For example, the SDT procedure may include the WTRU 102 sending, using a CG resource, a PUSCH transmission which includes a RRCResumeRequest message and an indication of a DL BWP, and receiving, using resources of the DL BWP, (i) one or more DL SDT payloads and/or (ii) a RRC message.

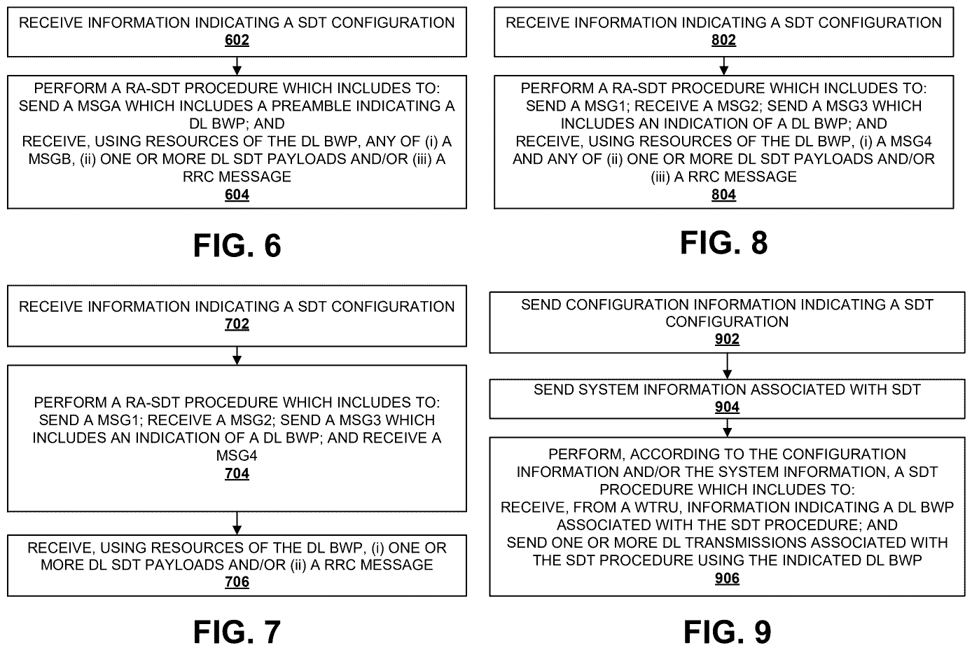

FIG. 6 is a procedural diagram illustrating an example procedure for indicating a DL BWP associated with a SDT procedure using RA, according to one or more embodiments of the present disclosure. As shown in FIG. 6, a WTRU 102 may receive information indicating a SDT configuration at 602. At 604, the WTRU 102 may perform a RA-SDT procedure (e.g., 2-step RA). The RA-SDT procedure may include the WTRU 102 sending a MsgA which includes a preamble indicating a DL BWP, and receiving, using resources of the DL BWP, any of (i) a MsgB, (ii) one or more DL SDT payloads and/or (iii) a RRC message.

FIG. 7 is a procedural diagram illustrating another example procedure for indicating a DL BWP associated with a SDT procedure using RA, according to one or more embodiments of the present disclosure. As shown in FIG. 7, a WTRU 102 may receive information indicating a SDT configuration at 702. At 704, the WTRU 102 may perform a RA-SDT procedure (e.g., 4-step RA). For example, the RA-SDT procedure may include the WTRU 102 sending a Msg1, receiving a Msg2, sending a Msg3 which includes an indication of a DL BWP, and receiving a Msg4. At 706, the WTRU 102 may (e.g., after contention resolution) receive, using resources of the DL BWP, (i) one or more DL SDT payloads and/or (ii) a RRC message.

FIG. 8 is a procedural diagram illustrating another example procedure for indicating a DL BWP associated with a SDT procedure using RA, according to one or more embodiments of the present disclosure. As shown in FIG. 8, a WTRU 102 may receive information indicating a SDT configuration at 802. At 804, the WTRU 102 may perform a RA-SDT procedure (e.g., 4-step RA). For example, the RA-SDT procedure may include the WTRU 102 sending a Msg1, receiving a Msg2, sending a Msg3 which includes an indication of a DL BWP, and receiving, using resources of the DL BWP, (i) a Msg4 and any of (ii) one or more DL SDT payloads and/or (iii) a RRC message.

FIG. 9 is a procedural diagram illustrating another example procedure for a SDT procedure using an indicated DL BWP, according to one or more embodiments of the present disclosure. As shown in FIG. 9, a base station (e.g., gNB 180, 6G node) may send configuration information indicating a SDT configuration at 902. At 904, the base station may send system information associated with SDT. At 906, the base station may perform, according to the configuration information and/or the system information, a SDT procedure. For example, the SDT procedure may include the base station receiving, from a WTRU 102, information indicating a downlink (DL) bandwidth part (BWP) associated with the SDT procedure, and sending one or more DL transmissions associated with the SDT procedure using the indicated DL BWP.

One or more embodiments provide a computer program comprising instructions which when executed by one or more processors cause such processors to perform the encoding and/or decoding methods according to any of the embodiments described above. One or more embodiments also provide a computer readable storage medium having stored thereon instructions for encoding or decoding video data according to the methods described above.

One or more embodiments provide a computer readable storage medium having stored thereon video data generated according to the methods described above. One or more embodiments also provide a method and apparatus for transmitting or receiving video data generated according to the methods described above.

The embodiments described herein may be implemented in, for example, a method or a process, an apparatus, a software program, a data stream, or a signal. Even if only discussed in the context of a single form of implementation (e.g., as a method), the implementation of such features may also be implemented in other forms. An apparatus may be implemented in, for example, appropriate hardware, software, and firmware. Corresponding methods may be implemented in, for example, a processor.

Various numeric values are used in the present application. Such specific values are for example purposes and the embodiments described are not limited to these specific values.

Various methods are described herein, and such methods comprise one or more steps or actions for achieving the described method. Unless a specific order of steps or actions is required for the proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an order to the operations unless specifically required.

The present disclosure may refer to “determining” various pieces of information. Determining information may include one or more of, for example, estimating, calculating, predicting, or retrieving (e.g., from memory) the information.

The present disclosure may refer to “accessing” various pieces of information. Accessing information may include one or more of, for example, receiving, retrieving (e.g., from memory), storing, moving, copying, calculating, determining, predicting, or estimating the information. Similarly, the present disclosure may refer to “receiving” various pieces of information. Receiving information may include one or more of, for example, accessing or retrieving (e.g., from memory) the information.

It is to be understood that use of any of the following “/”, “and/or”, and “at least one of” is intended to encompass all possible selections of listed items, taken either individually or in any combination thereof.

While specific embodiments have been described in the foregoing description in connection with the accompanying drawings, it should be understood that embodiments described herein are examples only and should not be taken as limiting the scope of the present disclosure or the following claims. Although features and elements are described herein in particular combinations, those of ordinary skill in the art will appreciate that such features or elements may be used alone or in any combination with the other features and elements. It is understood, therefore, that the overall teachings of the present disclosure are not limited to the particular embodiments, implementations, and examples disclosed herein, but are intended to cover variations, modifications, and alternatives as defined by the appended claims and any and all equivalents thereof.

1. A method implemented by a wireless transmit/receive unit (WTRU), the method comprising:
receiving configuration information indicating a small data transmission (SDT) configuration;
receiving system information indicating that SDT is configured for a cell;
performing, according to the configuration information and/or the system information, a SDT procedure which includes:
sending information indicating a downlink (DL) bandwidth part (BWP) associated with the SDT procedure, and
receiving one or more DL transmissions associated with the SDT procedure using the indicated DL BWP.

2. The method of claim 1, wherein the indicated DL BWP is an initial DL BWP or a control resource set (CORESET) #0.

3. The method of claim 1, wherein the system information indicates that SDT using the indicated DL BWP is supported by the cell, and/or the configuration information is associated with the cell.

4. The method of claim 1, wherein the information indicating the DL BWP is sent in an initial uplink (UL) transmission using a configured grant (CG) resource associated with the SDT configuration.

5. The method of claim 4, further comprising:
receiving, in response to the initial UL transmission using the CG resource, information indicating to use the indicated DL BWP to receive the one or more DL transmissions.

6. The method of claim 1, wherein the information indicating the DL BWP is sent in a first message of a two-step random access procedure.

7. The method of claim 1, wherein the information indicating the DL BWP is a random access preamble associated with the indicated DL BWP.

8. The method of claim 1, wherein the information indicating the DL BWP is sent in a third message of a four-step random access procedure.

9. The method of claim 1, wherein the one or more DL transmissions associated with the SDT procedure are received using the indicated DL BWP after completion of the random access procedure.

10. The method of claim 1, wherein the information indicating the DL BWP is a logical channel identifier (LCID), and the LCID further indicates a common control channel (CCCH) service data unit (SDU) in a medium access control (MAC) protocol data unit (PDU).

11. A wireless transmit/receive unit (WTRU) comprising:
a transceiver, memory, and a processor which are configured to:
receive configuration information indicating a small data transmission (SDT) configuration,
receive system information indicating that SDT is configured for a cell;
perform, according to the configuration information and/or the system information, a SDT procedure which includes to:
send information indicating a downlink (DL) bandwidth part (BWP) associated with the SDT procedure, and
receive one or more DL transmissions associated with the SDT procedure using the indicated DL BWP.

12. The WTRU of claim 11, wherein the indicated DL BWP is an initial DL BWP or a control resource set (CORESET) #0.

13. The WTRU of claim 11, wherein the system information indicates that SDT using the indicated DL BWP is supported by the cell, and/or the configuration information is associated with the cell.

14. The WTRU of claim 11, wherein the information indicating the DL BWP is sent in an initial uplink (UL) transmission using a configured grant (CG) resource associated with the SDT configuration.

15. The WTRU of claim 14, wherein the transceiver, the memory, and the processor are configured to:
receive, in response to the initial UL transmission using the CG resource, information indicating to use the indicated DL BWP to receive the one or more DL transmissions.

16. The WTRU of claim 11, wherein the information indicating the DL BWP is sent in a first message of a two-step random access procedure.

17. The WTRU of claim 11, wherein the information indicating the DL BWP is a random access preamble associated with the indicated DL BWP.

18. The WTRU of claim 11, wherein the information indicating the DL BWP is sent in a third message of a four-step random access procedure.

19. The WTRU of claim 11, wherein the one or more DL transmissions associated with the SDT procedure are received using the indicated DL BWP after completion of the random access procedure.

20. The WTRU of claim 11, wherein the information indicating the DL BWP is a logical channel identifier (LCID), and the LCID further indicates a common control channel (CCCH) service data unit (SDU) in a medium access control (MAC) protocol data unit (PDU).
